(19) United States
(12) Patent Application Publication
(10) Pub. No.: US 2005/0272022 A1
(43) Pub. Date: Dec. 8, 2005

(54) Method and Apparatus for Project Valuation, Prioritization, and Performance Management

(75) Inventors: Rodney A Montz Jr., San Antonio, TX (US); Michael S Javaherian, Farmers Branch, TX (US)

Correspondence Address: Rodney A Montz Jr, 406 Carpenter Cir, San Antonio, TX, 78258, US

(73) Assignee: ONRETURN LLC, San Antonio, TX (US)

(21) Appl. No.: 11/160,069

(22) Filed: Jun. 7, 2005

Related U.S. Application Data
(60) Provisional application No. 60/577,522, filed on Jun. 7, 2004.

(51) Int. Cl. G09B 3/00; G09B 7/00

(52) U.S. Cl. 434/322; 434/362

(57) ABSTRACT

The invention is a method and system for scoring and prioritizing projects. The scoring system uses a combination of factors to calculate and present a score and scorecard for a project. The score and scorecard “grade” the project based on its expected and/or actual impact on or for an organization. This invention includes an electronic channel for consulting or aiding customers with the use of the invention and related consulting.

### CROSS-REFERENCE TO RELATED APPLICATIONS

This application claims the benefit of provisional patent application Ser. No. 60/577,522 named “Method and System for Identifying, Assessing, and Prioritizing Initiatives” filed Jun. 7, 2004 by the present inventors.

### FEDERALLY SPONSORED RESEARCH

Not applicable

### SEQUENCE LISTING OR PROGRAM

Not applicable

### BACKGROUND OF THE INVENTION

1. Field of Invention

This invention relates to project management, more specifically to determining the value, prioritization, and performance of projects.

2. Prior Art

Common practice in project valuation, prioritization, and performance management is ad hoc and varies by project and organization. Many organizations use “intuition” as the primary criteria while others go through laborious number crunching efforts. Unfortunately, spreadsheets, the typical tool of choice for number crunching, are recreated for each project and difficult to leverage collaboratively across a team. The result is inconsistent, impeded decision-making that leads organizations to inefficient and ineffective project selection and execution. The typical large business leaves millions of dollars in lost return on investment on the table. These investment losses create a chain reaction by preventing or hindering future investments in more worthwhile projects. Given the combined investments of capital, scarce personnel, and other resources, a better solution is required.

Relevant Prior Art:
U.S. Pat. No. 6,578,004—Method and apparatus for facilitating management of information technology investment
U.S. Pat. No. 6,353,767—Method and system of confidence scoring
U.S. Pat. No. 6,675,149—Information technology project assessment method, system, and program product
U.S. Pat. No. 6,466,928—Method and apparatus for idea development and evaluation
U.S. Pat. No. 5,680,305—System and method for evaluating real estate
U.S. Pat. No. 6,556,992—Method and system for rating patents and other intangible assets

### OBJECTS AND ADVANTAGES

In summary, this invention channels scarce resources on the best projects, helps organizations achieve better results from the projects they pursue, and significantly reduces the resources and capital wasted on weaker projects. The purposes of this invention are to provide a method and system for rapidly and easily focusing on the projects that best fit an organization's needs and objectives. In addition, it enables organizations to:
flexibly rate projects based on their scope and other factors while structuring and reviewing the ratings in a consistent and easily interpreted fashion
reduce the complexities, miscalculations, hidden assumptions, and redundant work required to use spreadsheets to estimate a project's financial impact
easily comparing the pros and cons of pursuing projects regardless of their type, organizational geography, or organizational unit impact
more effectively balancing financial impact, which can be difficult to assess for some projects, and qualitative aspects, which deserve more focused and structured assessment
reduce the time and costs associated with receiving consulting or similar advice

In summary, the invention has the following advantages over prior art:
Single platform supporting multiple customers
Accessed and run over the internet (or any similar network)
Configurable for each customer while enabling shared or community templates
Zero installation: customers simply access the system without acquiring, installing, or maintaining their own hardware and software
Balance between qualitative, financial, and other metric-based factors
Focused on upfront identification, assessment, prioritization and selection of projects
Easy to answer and configure questions scored and organized into an intuitive scorecard
Ability to view multiple projects at a time and select one or more for more detailed analysis
Simple, easy to use variable and fixed financial calculations
No reliance on spreadsheets; enables single view across an organization that aids collaboration
Scores and related calculations update as data in the invention is updated
An electronic channel for consulting with and aiding customers

### SUMMARY

This invention relates to project management, more specifically to determining the value, prioritization, and performance of projects. It is comprised of stored or accessed data, configurable ratings, weighted relative scoring, configurable financial calculators, and related reporting and presentation.

### DRAWINGS

### Figures

Drawing figures included:

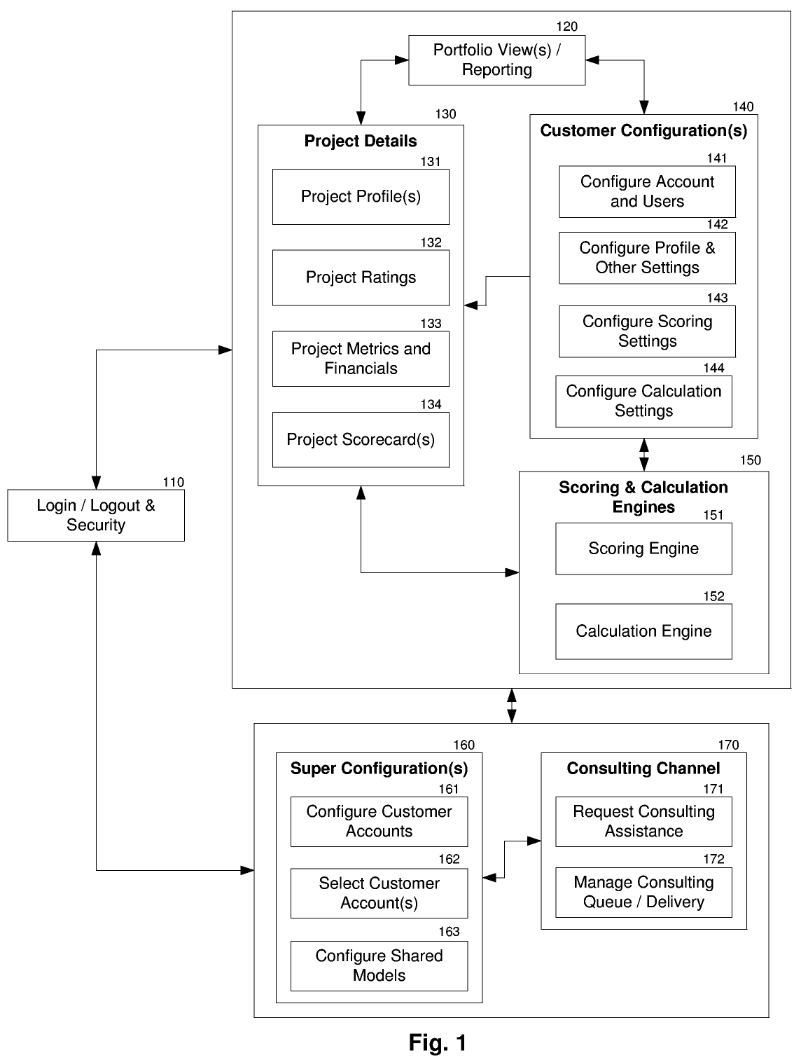

FIG. 1 shows the major functional components of the invention and their interactions (AKA Block Architecture)

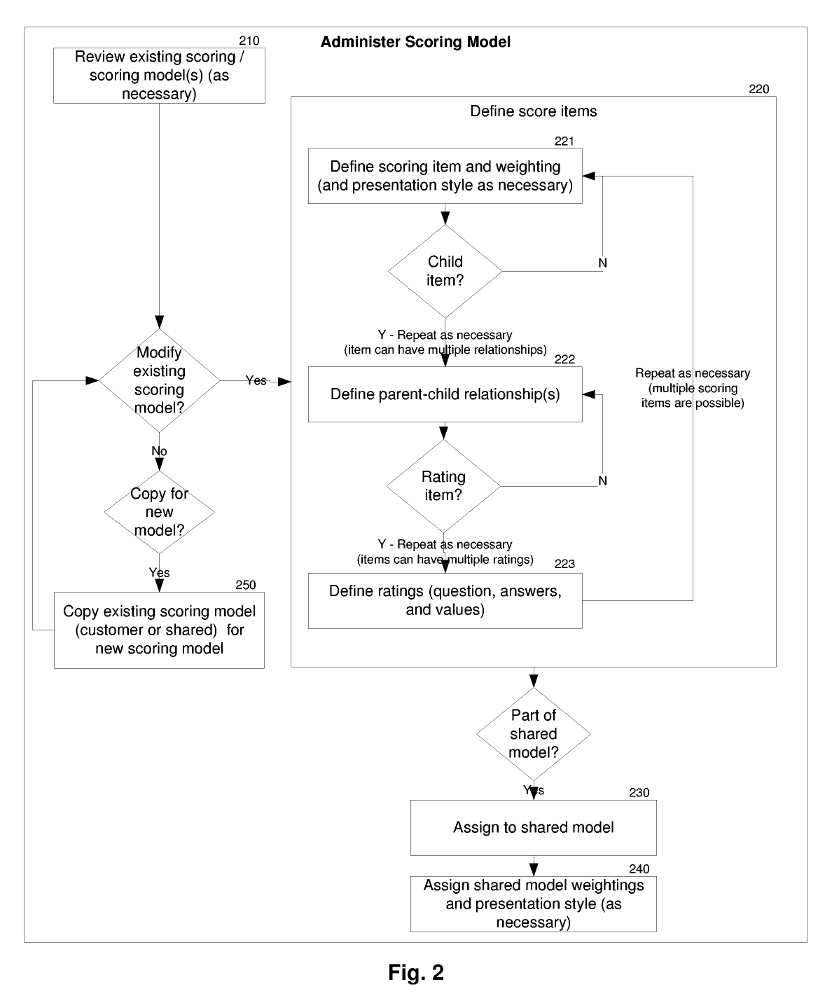

FIG. 2 is a workflow, from a customer or super administrator's perspective, for administering the rating model (AKA Administer Rating Model)

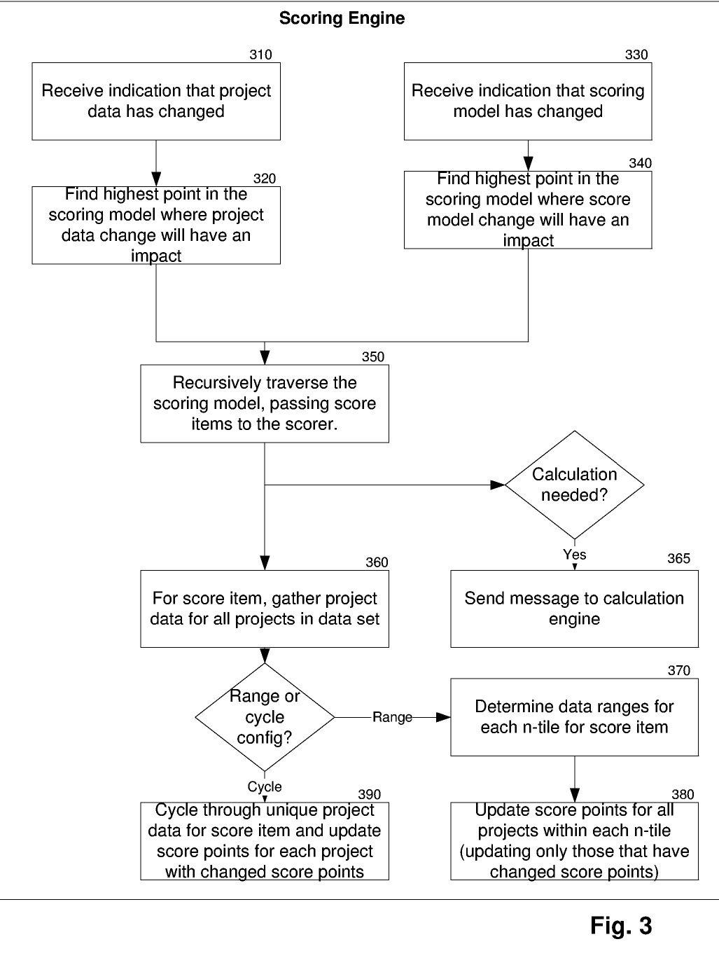

FIG. 3 shows the algorithm for calculating scores from a project's ratings (AKA Rating to Score Calculation Algorithm)

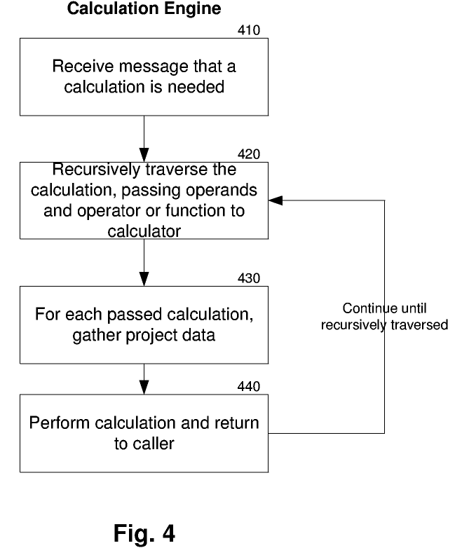

FIG. 4 shows the algorithm for calculating a project's financial estimates (AKA Financial Calculation Algorithm)

### DETAILED DESCRIPTION

### FIG. 1

FIG. 1 shows major components of the invention. As shown in FIG. 1, the invention is protected by a Secured Login 110 that prevents unauthorized access to the invention. Once a user logs into the invention, the invention only allows the user to access information specific to the user's customer account. The invention displays Portfolio View(s)/Reporting 120 showing all or a subset of the projects for that user's customer account. Portfolio View(s)/Reporting 120 can be used to analyze a set of projects in a comparative format (e.g., side-by-side, top-to-bottom, graphs) with rating scores, financials, and other critical decision-making information (displayed similarly as defined for Project Scorecard 134 below).

From this point, the user can select one or more projects to access in more detail via Project Details 130. Project Details 130 includes a project Profile 131 with basic project information (e.g., name, category, description, summary scores); Project Ratings 132 with question-answer style ratings; Project Metrics and Financials 133 with key metrics, variable and fixed financial estimates; and Project Scorecard 134 with scores and other select information. In addition, the user can add comments or explanatory text.

Project Ratings 132 enables the user to evaluate the project by responding to a series of questions from a list of predefined answers.

Project Metrics and Financials 133 enables the user to estimate and update the project's metrics and financials. Depending on the customer's configuration settings, metrics, financials, and other data may be entered directly into the system or accessed from an external source. A variable financial is defined as a mathematical combination of 2 or more variables and/or dollar factors resulting in financial amount. A fixed financial is any other type of financial amount. All financial amounts can be estimated by year for a number of years with cumulative and running totals. Other critical financial calculations, such as ROI, IRR, NPV, and Payback, is also displayed.

Project Scorecard 134 reports critical project information from 131, 132, and 133 in a single view for quick reference and decision support. Rating scores are shown as a combination of numbers (e.g., percentages, x out of y points) and graphics (e.g., horizontal bar graph indicating the project's score as compared with the maximum possible score) as configured for the customer account.

The invention allows for some users to take on additional access rights, such as those required to administer settings configurable for each customer. If the user has been granted customer-specific administration rights, AKA Customer Administrator, the user can also configure customer-specific settings via Customer Configuration(s) 140. Within Customer Configuration(s) 140, the Customer Administrator can define the customer and user accounts via Configure Users 141, configure basic settings via Configure Profile and Other Settings 142, configure scoring models via Configure Scoring Settings 143, and configure metric and other calculations via Configure Calculation Settings 144.

The invention calculates ratings, scores, and other calculations via the Scoring and Calculation Engines 150. The Scoring Engine 151 is further defined in FIG. 3 and its related description. The Calculation Engine 152 is further defined in FIG. 4 and its related description.

If the user has been granted cross-customer administration rights, AKA Super Administrator, the user can also configure customer accounts and related settings via Super Configuration(s) 160. Super Configuration(s) 160 enables Super Administrators to setup and define customer accounts via Configure Customer Accounts 161 and select a customer account to access via Select Customer Account(s) 162. In addition, similarly to the actions performed by a Customer Administrator for the customer's account, Super Administrators can define scoring models, ratings, and financial and other metric calculations that can be used by any customer via Configure Shared Models 163.

The invention enables users to receive consulting or similar advice via an electronic consulting channel 170. Any user can request consulting or similar assistance 171 from the provider (or its agents). The invention provides an easily accessible link or menu navigation to request consulting throughout its components. The consulting provider can review consulting requests and manage its work queue 172. The invention enables the availability of the electronic consulting channel to be configured on a customer basis via Configure Customer Accounts 161. The combination of the electronic consulting channel and other invention components enables a consulting provider to provide consulting assistance to a customer with specific references and/or access to customer information, accelerating the consulting process and helping the customer arrive at a specific solution more quickly and confidently.

### FIG. 2

The invention enables a scoring model to be assembled, applied to projects, and transformed into scores presented in a variety of ways. FIG. 2 shows how a user might configure a scoring model for a given customer account.

An Administrator (Customer Administrator or Super Administrator) can review existing rating/scoring model(s) 210 to determine whether a new rating model needs to be created or an existing rating model needs to modified, used, or copied.

Each scoring model is made up of score items or factors that together make up a project's total score. An Administrator can define these items via Define score items 220 (each defined via Define score item and weighting 221). As necessary, a score item can contain other score items to provide a hierarchical structure (via Define parent-child relationships 222). In addition, a score item can point to data, calculations, or ratings. Ratings are defined in question-answer like format via Define ratings 223. A scoring model for a given customer account can contain any number of scoring items.

An Administrator can assign 1 or more score items to a shared scoring model 230. An example use of a rating template would be to define a rating model for a particular type of project (e.g., IT, retail store site selection). A rating template can be assigned to specific project attributes, such as category, such that a user can select the category early in the process of defining a project and receive the benefits of predefined rating groups/financials applicable to that category of project. In addition, a Super Administrator can designate templates as accessible to any customer via Assign to Template 260. A given customer could have access to any number of templates.

An Administrator can define a shared model's weighting and presentation style 240. The weightings can be applied at any level in the model (e.g., score items, child score items, rating answer values).

An Administrator can copy an existing scoring model via Copy existing scoring model for new scoring model 250. Using this approach, an Administrator can quickly setup a new scoring model without having to create scoring items, parent-child relationships, and ratings individually.

### FIG. 3

FIG. 3 illustrates how a project's factors are transformed into scores for use and display throughout the invention. Two primary events trigger the need for the Scoring Engine to rescore all or part of the project scores for projects using a given scoring model:
(1) If any project data that is used by the scoring model to calculate project scores changes then the Scoring Engine will receive a message or indication that it needs to score some project data 310. Upon receiving this message, the Scoring Engine will traverse the scoring model to find the highest point in the model (parent-child relationships) where the project data change will impact project scores 320. From this point, the scoring engine will continue at 350.
(2) If all or part of the scoring model changes then the Scoring model will receive a message or indication that it needs to score some project data 330. Upon receiving this message, the Scoring Engine will find the highest point in the scoring model where the scoring model change will impact project scores 340.

Using the high impact point score item (from either 320 or 340), the Scoring Engine begins scoring score items using a recursive function that traverses down the tree then back up to the high impact point score item, passing score items to the scorer (350).
(1) The scorer begins by collecting project data that is linked to the passed score item in preparation for scoring the projects in the dataset (360). It also determines whether the passed score item requires a data calculation before being scored. If calculation(s) are required, then the scorer sends a message to the Calculation Engine (365).
(2) For each passed score item, the scorer will determine whether to apply a range or cycle-based scoring approach. If the scorer selects the range-based approach, it will determine the project data ranges that make up each n-tile for the score item (370). Otherwise, it will use the cycle-based approach for scoring (390). In the cycle-based approach, the scorer cycles through unique project data and assigns the appropriate score points based on the number of projects in the dataset that have project data that is higher and lower than the current unique project data being processed. This will continue until all projects in the dataset have been scored for the passed score item.
(3) If using the range-based approach, the scorer will update projects' score points based on where the project's data falls into each n-tile range (390).

### FIG. 4

FIG. 4 shows the essential operation of the Calculation Engine.
(1) The Calculation Engine is triggered by a message that a calculation is needed (410).
(2) Next, the Calculation Engine recursively traverses the required calculation (if hierarchical) passing operands and operator or function to the calculator (420). This process will continue until the entire calculation model has been traversed and processed.
(3) For each passed calculation, the calculator gathers linked project data for the given dataset (430).
(4) To complete the calculation, the calculator applies the operator or function to the appropriate project data as defined by the project data to operand link (440). Following the calculation, the calculator returns to the recursive caller (420).

1. A method comprising: storing and/or accessing data associated with valuation and performance factors of projects where factors are any combination of multiple choice questions with valued answers, calculated values, and metrics; and generating scores using said data based on each project's data relative to sets of other projects.

2. A method comprising: storing and/or accessing data associated with valuation and performance factors of projects where factors are any combination of multiple choice questions with valued answers, calculated values, and metrics; organizing factors into a weighted model for generating a hierarchy of relative scores; and generating scores using said data based on each project's data relative to sets of other projects.

3. A method comprising: storing and/or accessing data associated with valuation and performance factors of projects where factors are any combination of multiple choice questions with valued answers, calculated values, and metrics; calculating factors using a predefined or supplied calculation; organizing factors into a weighted model for generating a hierarchy of relative scores; and generating scores using said data based on each project's data relative to sets of other projects.

4. A method comprising: defining and storing weighted models for generating a hierarchy of scores wherein scores are defined as a single score or a weighted calculation of two or more scores; linking weighted scoring models with projects' valuation and performance factor data for the purpose of scoring and reporting; and calculating scores using a predefined or supplied calculation.

5. A method comprising: storing and/or accessing data associated with valuation and performance factors of projects where factors are any combination of multiple choice questions with valued answers, calculated values, and metrics; defining and storing factor calculations wherein calculations are defined a hierarchy of mathematical operators or functions, one or more operands, and one or more resulting factors; linking factor calculations with projects' valuation and performance factor data for the purpose of calculation and reporting; and calculating factors using a predefined or supplied calculation.

6. A method comprising: storing and/or accessing data associated with valuation and performance factors of projects where factors are any combination of multiple choice questions with valued answers, calculated values, and metrics; and generating scores as a series of visual objects representing a project's relative ranking on an n-tile basis where n represents a percentile based ranking such as quintiles.

7. A method comprising: storing requests, responses, and related status for consulting relative to project valuation and/or performance; communicating said requests to consulting provider and providing access to relevant project content and requestor's request; and communicating consulting responses to said request and tracking the interactive conversation of the consulting requestor and provider.
